(19) United States
(12) Patent Application Publication
(10) Pub. No.: US 2010/0275356 A1
(43) Pub. Date: Nov. 4, 2010

(54) Plunger cleaning system

(76) Inventors: Justin A. Hovsepian, Oakhurst, NJ (US); Alexander Hovsepian, Oakhurst, NJ (US)

Correspondence Address: Hollstein Keating Cattell Johnson & Goldstein P.C., Willow Ridge Executive Office Park, 750 Rt. 73S., Suite 301, Marlton, NJ, 08053, US

(21) Appl. No.: 12/799,679

(22) Filed: Apr. 29, 2010

Related U.S. Application Data
(60) Provisional application No. 61/215,261, filed on May 4, 2009.

(51) Int. Cl. E03D 11/00; B08B 7/00

(52) U.S. Cl. 4/255.11; 134/42

(57) ABSTRACT

A plunger cleaning system has a plunger having a plunger head and an elongated handle extending from the plunger head, and a sanitizing cleaning element having a center opening. The cleaning element is a water soluble, cleansing disinfectant solid compound which rapidly dissolves in water. The soiled plunger head is placed and submerged within the toilet basin, with the handle extending upward. The cleaning element is then positioned over the handle, with its center opening aligned over the upper end of the handle. The cleaning element is dropped onto the handle and allowed to slide down to the plunger head, where it contacts the water and dissolves around and cleans and disinfects the plunger head and lower end of the handle. Lamina borders around the center opening and outside perimeter surface of the cleaning element are provided to direct the flow of dissolved material from the cleaning element around and under the plunger head and up the lower end of the handle.

This application claims the benefit of parent application 61/215,261 filed on May 4, 2009.

### BACKGROUND OF THE INVENTION

Unclogging stopped up toilets is not a particularly pleasant job, but it is a necessary task in many households. Unless one calls upon a plumber or other plumbing professional, a plunger is routinely used to address the problem of a clogged toilet. Unfortunately, plunging a toilet is wet, messy, and dirty. Even after the toilet is cleared, one is left with an unsanitary plunger head which has been in contact with the water and waste in the toilet's basin. Flushing the unclogged toilet with clean water while the plunger remains in the basin of the toilet will be only minimally effective in rinsing the plunger head, but will not clean or sanitize it. Moreover, the user must still remove the dripping wet and dirty plunger head from the basin and then transport, wash and disinfect it elsewhere, e.g. in a sink or bath tub, areas which obviously should not come in contact with wastewater.

There currently is no easy, effective and sanitary means of cleaning and disinfecting a plunger which has been used in a toilet basin and certainly no in situ means of doing so.

### SUMMARY OF THE INVENTION

It is thus the object of the present invention to provide a clean and effective system for and method of cleaning and sanitizing a plunger immediately after it is used and while it is still in the toilet basin.

This object is accomplished by the present invention, a plunger having a plunger head and an elongated handle extending from the plunger head, and a sanitizing cleaning element having a center opening. The cleaning element is a water soluble, cleansing disinfectant solid compound which rapidly dissolves in water. The soiled plunger head is placed and submerged within the toilet basin, with the handle extending upward. The cleaning element is then positioned over the handle, with its center opening aligned over the upper end of the handle. The cleaning element is dropped onto the handle and allowed to slide down to the plunger head, where it contacts the water and dissolves around and cleans and disinfects the plunger head and lower end of the handle. Lamina borders around the center opening and perimeter outside surface of the cleaning element are provided to direct the flow of dissolved material from the cleaning element around and under the plunger head and up the lower end of the handle.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is a perspective view of the cleaning element of the present invention.

FIG. 2 is a view of the cleaning element aligned over the plunger, for use in accordance with the present invention.

FIG. 3 is a view of the cleaning element being slid down the plunger handle, in accordance with the present invention.

FIG. 4 is a partial section view of the plunger head cleaning, sanitizing and disinfecting process of the plunger cleaning system of the present invention.

FIG. 5 is a close-up view of that which is shown in FIG. 4.

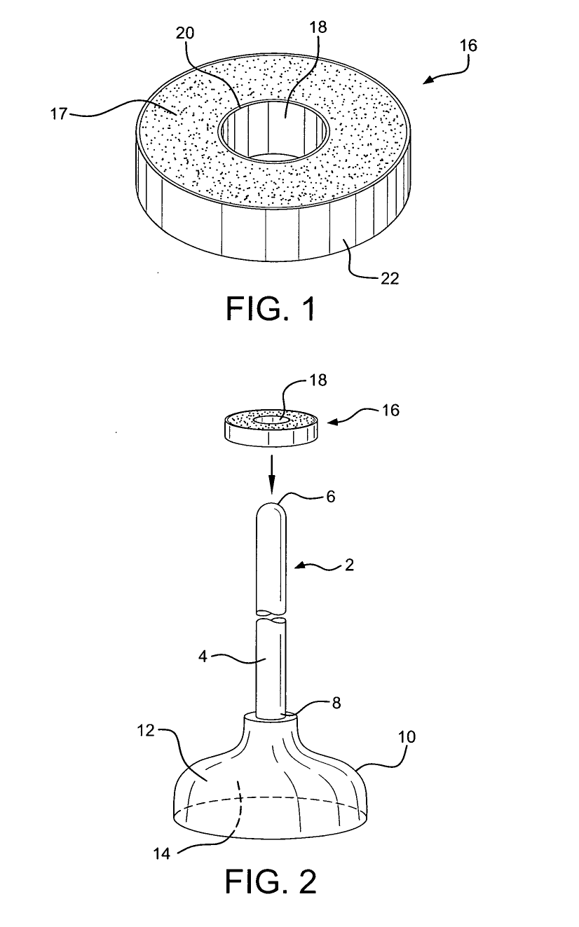

### DETAILED DESCRIPTION OF THE INVENTION

The plunger cleaning system of the present invention comprises plunger 2 and cleaning element 16. Plunger 2 has elongated handle 4 of given diameter with upper end 6 and lower end 8. Plunger head 10 has outer surface 12 and inner surface 14 and is connected to lower end 8 of handle 4. Cleaning element 16 has center opening 18 having a diameter which is slightly larger than the diameter of handle 4. Cleaning element 16 can be doughnut shaped; however, it is not restricted to this shape. It can be configured as having any convenient or desired shape which has a center opening.

Cleaning element 16 is a unitary body, whether doughnut or other shape. It is made of a water soluble, sanitizing, lavatory cleansing disinfectant, solid compound which is quickly dissolvable when placed in contact with water. There are numerous such compounds, many of which are formed from powders compressed into tablets, cakes or the like. Examples of these products are found in U.S. Pat. Nos. 6,713,441, 5,350,563, 4,308,625, and 4,043,931. The subject invention does not claim novelty based on the type of water soluble, cleansing compound used in cleaning element 16. It is contemplated that cleaning element 16 can comprise existing compounds which act as sanitizing, disinfectant cleaners, rapidly dissoluble in water.

Cleaning element 16 also comprises lamina border 20 around center opening 18 and lamina border 22 around the outside perimeter surface of cleaning element 16. Lamina borders 20 and 22 can each be a thin tissue or gelatin membrane, or a layer of the material used in cleaning element 16 itself, but more highly compressed. The lamina borders can be comprised of any substance or compound which forms a thin, soluble, biodegradable, environmentally safe material which will decompose and dissolve quickly, but not before internal cleaning material 17 making up cleaning element 16 itself dissolves. As a result, once cleaning element is placed in contact with water, lamina borders 20 and 22 will remain in tact longer than the soluble material forming cleaning element 16.

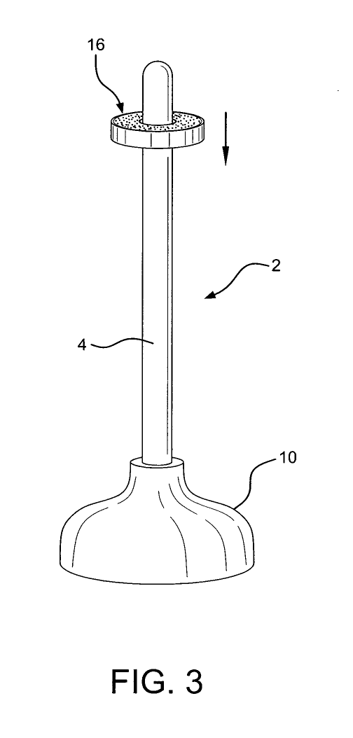

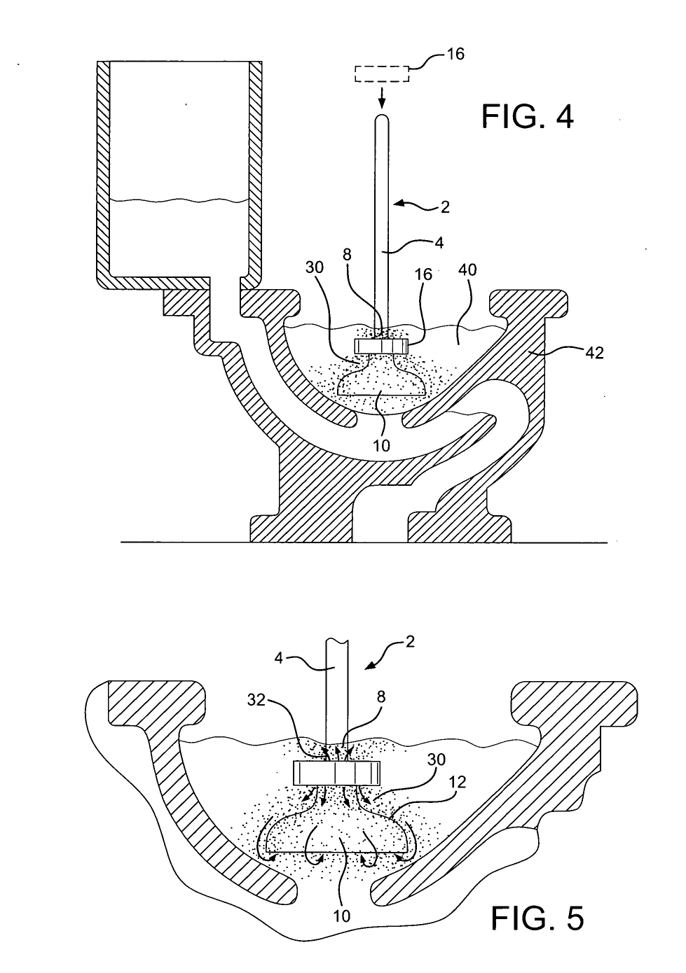

In use, the plunged, unclogged toilet is flushed so that water 40 in toilet basin 42 is relatively clean, but clearly not disinfected. As shown in FIGS. 4 and 5, plunger head 10 of plunger 2 is positioned in water 40 so that it, and the soiled section of lower end 8 of handle 4 are submerged and the handle is vertical, extending upright from toilet basin 42. Cleaning element 16 is placed above upper end 6 of handle 4, see FIG. 2, with center opening 18 aligned over the upper end. Cleaning element 16 is then dropped onto and allowed to slide down handle 4, see FIG. 3, until it contacts plunger head 10. The water engulfing plunger head 10 acts to rapidly dissolve the soluble, cleaning material 17 of cleaning element 16.

As shown in FIGS. 4 and 5, a majority of this dissolving cleaning material 30 is directed by less soluble lamina border 22 along outer surface 12 of plunger 2, along lower end 8 of handle 4, and ultimately around and beneath the entire plunger, including inner surface 14. Lamina border 20 assists in directing some of the dissolved material 32 up towards handle 4, to clean lower end 8 of the handle. Lamina borders 20 and 22 will eventually also dissolve and, if comprised of cleansing material, will assist in the cleaning and disinfecting operation.

It is contemplated that cleaning elements 16 of the plunger cleaning system of the invention can be stored on or with handle 4 or dispensed from a separate container for use when needed. In either case, the system provides a quick, efficient and sanitary means of cleaning and disinfecting a plunger after it is utilized in the basin of a toilet.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A plunger cleaning system comprising:
a plunger comprising an elongated handle having a given diameter and an upper and a lower end, and a plunger head secured to the lower end of the handle, said plunger head having an outer surface and an inner surface; and
a cleaning element having a center opening which has a diameter greater than the diameter of the handle, said cleaning element being comprised of a water soluble, sanitizing, disinfectant cleaning material, whereby the cleaning element is configured to be placed over the upper end of the handle and dropped on and slid down the handle to the outer surface of the plunger in order to clean and disinfect the plunger head and lower end of the handle.

2. The plunger cleaning system as in claim 1 wherein the cleaning material comprising the cleaning element is configured to dissolve upon contact with water.

3. The plunger cleaning system as in claim 2 wherein the cleaning element comprises lamina means around the center opening for directing dissolved cleaning material along the handle.

4. The plunger cleaning system as in claim 2 wherein the cleaning element comprises lamina means around the outside perimeter surface of the cleaning element for directing dissolved cleaning material along the outer surface of the plunger and along the handle.

5. The plunger cleaning system as in claim 3 wherein the cleaning element further comprises second lamina means around the outside perimeter surface of the cleaning element for directing dissolved cleaning material along the outer surface of the plunger.

6. The plunger cleaning system as in claim 5 wherein the lamina means and the second lamina means comprises highly compressed water soluble, sanitizing, disinfectant cleaning material.

7. The plunger cleaning system as in claim 5 wherein the lamina means and the second lamina means comprise a thin tissue membrane.

8. The plunger cleaning system as in claim 5 wherein the lamina means and the second lamina means comprise a thin gelatin membrane.

9. The plunger cleaning system as in claim 1 wherein the cleaning element is doughnut shaped.

10. A method of cleaning a plunger within water in a toilet basin comprising the steps of:
providing a plunger comprising an elongated handle having a given diameter and an upper and a lower end, and a plunger head secured to the lower end of the handle, said plunger head having an outer surface and an inner surface;
providing a cleaning element having a center opening which has a diameter greater than the diameter of the handle, said cleaning element being comprised of a water soluble, sanitizing, disinfectant cleaning material;
positioning the plunger head in the water of the toilet basin;
placing the cleaning element over the upper end of the handle such that its center opening is aligned over the handle;
dropping the cleaning element down the handle;
sliding the cleaning element down the handle until it rests on the outer surface of the plunger head;
dissolving the cleaning material of the cleaning element within the water; and
directing the soluble, sanitizing, disinfectant cleaning material of the cleaning element over the plunger head and the lower end of the handle to clean the plunger head and the handle.

11. The method as in claim 10 comprising the further steps of:
providing a lamina border of highly compressed water soluble, sanitizing, disinfectant cleaning material around the outside perimeter surface of the cleaning element;
directing the flow of dissolved, soluble, sanitizing, disinfectant cleaning material from the lamina border along the outer surface of the plunger head and along the handle; and
directing the flow of dissolved, soluble, sanitizing, disinfectant cleaning material from the lamina border along the inner surface of the plunger head.

12. The method as in claim 10 comprising the further steps of:
providing a lamina border of highly compressed water soluble, sanitizing disinfectant cleaning material around the center opening of the cleaning element; and
directing the flow of dissolved, soluble, sanitizing, disinfectant material from the lamina border along the handle of the plunger.

13. The method as in claim 12 comprising the further steps of:
providing a second lamina border of highly compressed water soluble, sanitizing, disinfectant cleaning material around the outside perimeter surface of the cleaning element;
directing the flow of dissolved, soluble, sanitizing, disinfectant cleaning material from the second lamina border along the outer surface of the plunger head; and
directing the flow of dissolved, soluble, sanitizing, disinfectant cleaning material from the second lamina border along the inner surface of the plunger head.

14. The method as in claim 10 comprising the further steps of:
providing a lamina border comprising a thin tissue membrane around the outside perimeter surface of the cleaning element;
directing the flow of dissolved, soluble, sanitizing, disinfectant cleaning material from the lamina border along the outer surface of the plunger head and along the handle; and
directing the flow of dissolved, soluble, sanitizing, disinfectant cleaning material from the lamina border along the inner surface of the plunger head.

15. The method as in claim 10 comprising the further steps of:
providing a lamina border comprising a thin tissue membrane around the center opening of the cleaning element; and
directing the flow of dissolved, soluble, sanitizing, disinfectant cleaning material from the lamina border along the handle of the plunger.

16. The method as in claim 15 comprising the further steps of:
providing a second lamina border comprising a thin tissue membrane around the outside perimeter surface of the cleaning element;
directing the flow of dissolved, soluble, sanitizing, disinfectant cleaning material from the second lamina border along the outer surface of the plunger head; and
directing the flow of dissolved, soluble, sanitizing, disinfectant cleaning material from the second lamina border along the inner surface of the plunger head.

17. The method as in claim 10 comprising the further steps of:
providing a lamina border comprising a thin gelatin membrane around the outside perimeter surface of the cleaning element;
directing the flow of dissolved, soluble, sanitizing, disinfectant cleaning material from the lamina border along the outer surface of the plunger head and along the handle; and
directing the flow of dissolved, soluble, sanitizing disinfectant cleaning material from the lamina border along the inner surface of the plunger head.

18. The method as in claim 10 comprising the further steps of:
providing a lamina border comprising a thin gelatin membrane around the center opening of the cleaning element; and
directing the flow of dissolved, soluble, sanitizing, disinfectant cleaning material from the lamina border along the handle of the plunger.

19. The method as in claim 18 comprising the further steps of:
providing a second lamina border comprising a thin gelatin membrane around the outside perimeter surface of the cleaning element;
directing the flow of dissolved, soluble, sanitizing, disinfectant cleaning material from the second lamina border along the outer surface of the plunger head; and
directing the flow of dissolved, soluble, sanitizing disinfectant cleaning material from the second lamina border along the inner surface of the plunger head.
